(19) United States
(12) Patent Application Publication
(10) Pub. No.: US 2026/0152923 A1
(43) Pub. Date: Jun. 4, 2026

(54) DRIVETRAIN FOR HYBRID VEHICLE WORK VEHICLE

(71) Applicant: Deere & Company, Moline, IL (US)

(72) Inventors: Steven R. Whiteman, Asbury, IA (US); Skyler S. Hagen, Platteville, WI (US); Randall L. Long, Coffeyville, KS (US)

(21) Appl. No.: 18/966,234

(22) Filed: Dec. 3, 2024

(51) Int. Cl. E02F 9/20

(52) U.S. Cl. CPC E02F 9/2075

(57) ABSTRACT

A hybrid drivetrain for a work vehicle includes an internal combustion engine a hydraulic pump, electric machine, and an overrunning clutch. The work vehicle can include hydraulic actuators and work tools powered by the hydraulic pump and electric drive motors powered by the electric machine. The overrunning clutch couples the engine, the pump, and the electric machine so that the engine can drive the electric machine and pump in a first mode, the engine and the electric machine can simultaneously drive the hydraulic pump in a second mode, and the electric machine can drive the hydraulic pump while overrunning the clutch in a third mode. A torsional detuner can couple the overrunning clutch to a flywheel of the engine.

### FIELD OF THE DISCLOSURE

The present disclosure generally relates to hybrid work vehicle drivetrains including but not limited to drivetrains for skid steer loaders or compact track loaders, and more specifically to internal combustion engine and electric hybrid powered drivetrains used in work vehicles with hydraulically powered actuators.

### BACKGROUND

A desire for lower emissions and lower fossil fuel consumption has led to the development of work vehicles that combine internal combustion engines and battery operated electric motors to power hybrid drivetrains in machines with hydraulically powered actuators or work tools. To be desirable to users, these hybrid work vehicles must meet form factor, size, weight, and cost constraints similar to traditional internal combustion engine powered work vehicles. Because typical hybrid powered work vehicles have required expensive, complex and bulky systems to combine the output of internal combustion engines and electric motors into their drivetrains, there is a continuing need for simpler, more compact, and less costly drivetrain systems.

### SUMMARY OF THE DISCLOSURE

In one embodiment a work vehicle drivetrain includes an internal combustion engine having an engine output, a hydraulic pump having a pump input, an electric machine having an electric machine shaft; and an overrunning clutch that couples the engine output, the pump input, and the electric machine shaft. The internal combustion engine can drive the electric machine and pump in a first mode, the internal combustion engine and the electric machine can simultaneously drive the hydraulic pump in a second mode, and the electric machine can drive the hydraulic pump while overrunning the clutch in a third mode. In some embodiments, the overrunning clutch also includes a drive race coupled to the engine output and a driven race that couples the overrunning clutch, the pump input, and the electric machine shaft via a coupling gear. Optionally, the drive race of the overrunning clutch can be coupled to the engine output via a torsional detuner which can be a spring type torsional detuner.

In such a drivetrain, the electric machine can be electrically connected to an electric drive motor that is mechanically connected to a ground engaging unit and configured to drive the vehicle along a ground surface. The electric machine can be configured to supply electric power to the electric drive motor. According to another option, the drivetrain can also include an electrical power storage system, and a controller configured to control the electrical power storage system, the electric machine, the electric drive motor, the hydraulic pump and the internal combustion engine. Under this option, the electrical power storage system is electrically connected to the electric drive motor and the electric machine. The controller can be further configured to control the electrical power storage system to supply electrical power to the electric machine and to the electric drive motor. The controller can also be configured to control the electric machine to supply electrical power to the electrical power storage system.

According to a further option such a drivetrain can further include a frame, a work tool coupled to the machine frame, and a positioning actuator hydraulically coupled to the hydraulic pump. The positioning actuator can be configured to adjust the position of the work tool relative to the frame. The controller is further configured to control the internal combustion engine and the electric machine to drive the hydraulic pump in the second mode to meet a target hydraulic load output without freewheeling the overrunning clutch.

In other aspects of the disclosure, the electrical power transfer connection on the work vehicle provides an interface for other types of electrical accessories such as electrically powered work tools.

Numerous objects, features and advantages of the present invention will be readily apparent to those skilled in the art upon a review of following description in conjunction with the accompanying drawings.

### BRIEF DESCRIPTION OF THE DRAWINGS

FIG. 1 is a left side view of a diesel electric hybrid powered work vehicle, for example a skid steer loader, with drive wheels and a work tool coupler connected to the front of the work vehicle.

FIG. 2 is a right side view of a diesel electric hybrid powered work vehicle, for example a skid steer loader, with track units and a dozer blade connected to the front of the work vehicle via work tool coupler.

FIG. 3 is an enlarged left side view of the front portion of the work vehicle of FIG. 1 with the work tool coupler engaged with a coupler receiver of a work tool, which in the illustrated example is a bucket.

FIG. 4 is a schematic left side view of the front portion of the work vehicle showing the work tool coupler together with a schematic diagram of the work vehicle's hydraulic system. A hydraulically powered auger work tool is attached to the work tool coupler and connected to the hydraulic system.

FIG. 5 is an isometric view of a diesel electric hybrid drivetrain of a tracked skid steer loader work vehicle.

FIG. 6 is a top view of the drivetrain of a tracked skid steer loader work vehicle of FIG. 5.

FIG. 7 is an isometric view of the diesel engine, electric machine, hydraulic pump subassembly of the hybrid drivetrain of FIG. 5.

FIG. 8A is an isometric cutaway view of an overrunning clutch showing an outer race rotating clockwise relative to an inner race to lock the two races together.

FIG. 8B is an isometric cutaway view of an overrunning clutch showing an outer race rotating counterclockwise relative to an inner race, allowing free rotation of the two races.

FIG. 9 schematically illustrates one embodiment of the diesel engine, electric machine, hydraulic pump subassembly of the hybrid drivetrain of FIG. 5.

FIG. 10 schematically illustrates a second embodiment of the diesel engine, electric machine, hydraulic pump subassembly of the hybrid drivetrain of FIG. 5.

FIG. 11 is a table listing operating states of drivetrain components during different controller modes.

### DETAILED DESCRIPTION

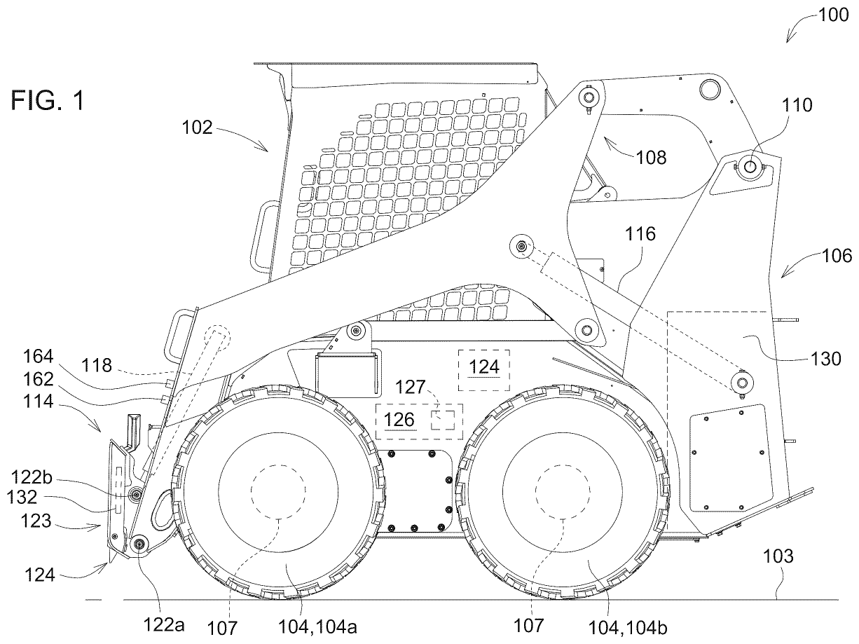

FIG. 1 is a left side view of a one embodiment of a hybrid electric and internal combustion engine powered work vehicle 100. Work vehicle 100 is illustrated as a skid steer loader, which may also be referred to a skid steer, but may be any work vehicle which may connect to a work tool with a retention assembly, such as backhoe loader, compact track loader, excavator, tractor, tractor loader, and wheel loader, to name a few examples. Work vehicle 100 may perform a number of work operations, including excavating or loading material, shaping or smoothing ground surfaces, excavating or boring a hole, or breaking up a material, to name but a few operations. As used herein, directions with regard to work vehicle 100 may be referred to from the perspective of an operator seated within operator station 102: the left of work vehicle 100 is to the left of such an operator, the right of work vehicle 100 is to the right of such an operator, the front or fore of work vehicle 100 is the direction such an operator faces, the rear or aft of work vehicle 100 is behind such an operator, the top of work vehicle 100 is above such an operator, and the bottom of work vehicle 100 is below such an operator. The operator station 102 can provide a centralized ergonomic interface for the operator to issue commands and receive feedback to control the work machine functions and features using pedals, levers, buttons, switches and display screens.

Work vehicle 100 includes a hydraulic system 124 and an electrical system 126 powered by an internal combustion engine (“ICE”) 130. A controller 128 is operatively coupled to the internal combustion engine 130, the hydraulic system 124, the electrical system 126, the operator station 102 and to various sensors that monitor the work vehicle's operating parameters. Controller 128 is configured to control the operation of ICE 130, hydraulic system 124 and electrical system 126, based on commands it receives from operator station 102 and signals controller 128 receives from sensors. ICE 130 can be located within a compartment near the rear of work vehicle 100 and is coupled to drive an electric machine 120 and a hydraulic pump 148. ICE 130 produces power through an output shaft which rotates to drive connected components. When driven by ICE 130, electric machine 120 generates electrical power which it can supply to electrical system 126. In addition to components that consume electrical power, like electric motors, electrical system 126 can include an electrical power storage device, such as battery 127. Alternatively, other energy storage devices such as capacitive storage may be included. Controller 128 is configured to control electrical power storage device charging and power supply, as well as to control the operation of other electric components.

Controller 128 is configured to operate electric machine 120 as an electric motor using electric power from the battery to drive hydraulic pump 148. Controller 128 can operate electric machine 120 as the sole power source for the hydraulic pump 148, or else can simultaneously operate the ICE 130 and use electric machine 120 to supplement ICE output to reduce fuel consumption or else to boost the power supplied to the hydraulic pump beyond what ICE 130 alone can produce. When controller 128 operates ICE 130 to drive electric machine 120 and use electric machine 120 as a generator, controller 128 can supply electric power from electric machine 120 to charge battery 127 or to drive electric power consuming devices such as electric motors and actuators.

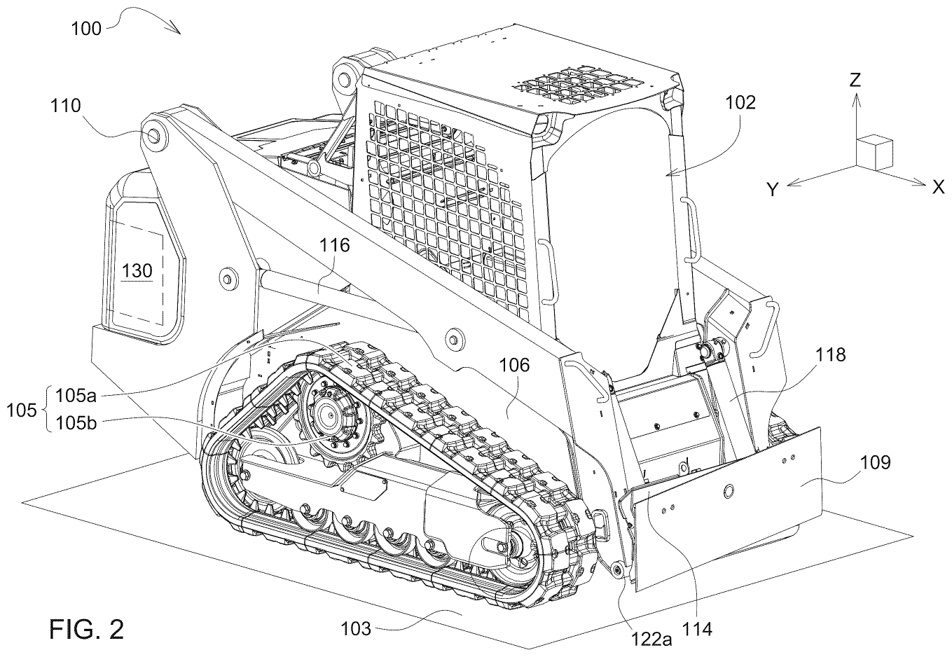

Work vehicle 100 is supported from or on the ground surface 103 by ground engaging units 104, which provide rolling support and traction to work vehicle frame 106. The ground engaging units 104 may be drive wheels 104a, 104b that support the work vehicle directly from the ground surface 103. FIG. 2 is an alternative embodiment of work vehicle 100 in which the ground engaging units 104 can be crawler track units 105 that include crawler tracks 105a driven by one or more sprockets or track wheels 105b. In these work vehicles, electric drive motors 107 connected to one or more of the drive wheels 104a, 104b, or sprockets 105b rotate the connected drive wheels or sprockets 105b to propel the work vehicle 100 along the ground surface 103.

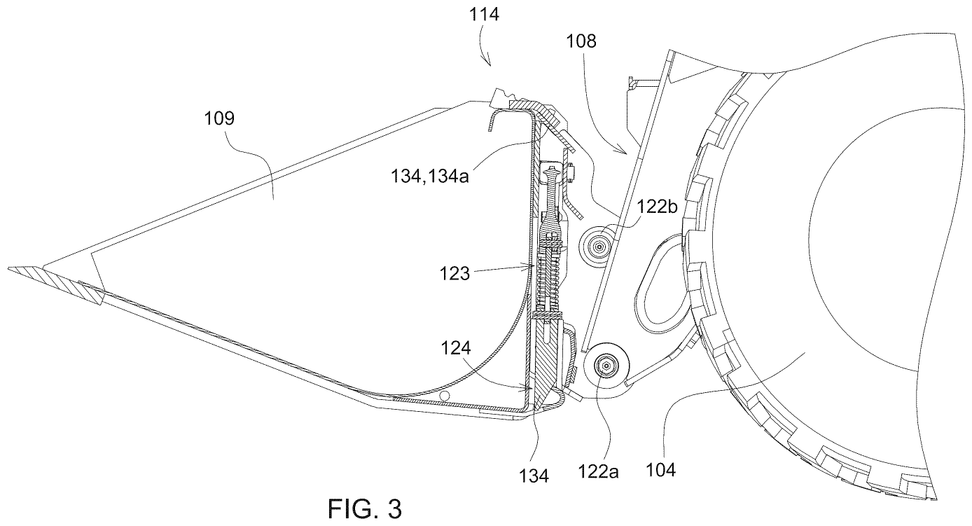

Work vehicle frame 106 provides strength and support to work vehicle 100, and interconnects the components of work vehicle 100, including boom 108. Boom 108, which may also be referred to as a linkage, is pivotally connected to work vehicle frame 106 via one or more pins 110. These pivotal connections allow work vehicle 100 to raise and lower boom 108, which in turn raises and lowers a work tool coupler 114 and any work tools attached to the work tool coupler 114. In FIG. 3 the work tool coupler 114 is shown attached to an exemplary work tool 109 in the form of a bucket. Work vehicle 100 may raise and lower boom 108 via the extension and retraction of double-acting lift hydraulic cylinders 116 by supplying hydraulic fluid to a rod end or piston end of the hydraulic cylinder and withdrawing hydraulic fluid from the opposite end.

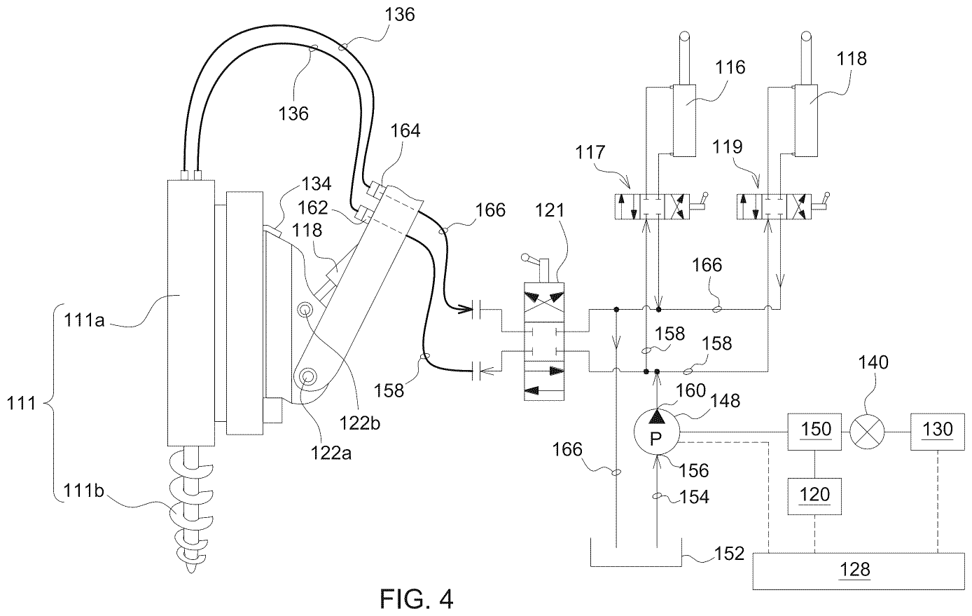

As further described below regarding the hydraulic schematic diagram of FIG. 4 each hydraulic cylinder 116 may be controlled by hydraulic control valves, such as boom valve 117, which selectively supplies hydraulic fluid from a hydraulic pump 148. Similarly, work tool coupler 114 may also be tilted relative to boom 108 by tilt cylinders 118, controlled by hydraulic control valves such as coupler control valve 119 which selectively supplies hydraulic fluid from hydraulic pump 148. These hydraulic actuators 116, 118 allow the work tool 109 attached to work tool coupler 114 to perform a function, such as a bucket 109 which may be tilted upwards to gather material or downwards to dump material.

Work tool coupler 114 is pivotally connected at one end of boom 108 via pins 122a and is pivotally connected at one longitudinal end of each of tilt cylinders 118 by pins 122b. Work tool coupler 114 may thereby transmit forces between a work tool 109 attached to work tool coupler 114, boom 108, and tilt cylinders 118, allowing the work tool 109 to be raised, lowered, and tilted relative to work vehicle frame 106. Work tool coupler 114 includes body 123, the rigid structure which provides strength and carries forces for work tool coupler 114, and latch 112, which aids in retaining and securing the work tool 109 to coupler 114. Latch 112 preferably includes a mechanism which allows work tools to be retained in an engaged position with work tool coupler 114, such as when work vehicle 100 is operating with the work tool 109, or released from engagement, such as when a work tool 109 is being exchanged for another work tool. Examples of various configurations for a work tool coupler with associated coupler receiver 134 and latching mechanisms can be seen in U.S. Pat. Nos. 5,252,022; 10,550,541; and 10,294.629, and 11,890,953 the details of which are incorporated herein by reference. The coupler receiver 134 may for example be constructed as shown in FIG. 3, and as further described in U.S. Pat. No. 9,624,621.

The work tool coupler 114 is configured to selectively interconnect the work vehicle 100 with a coupler receiver 134 of a selected one of a plurality of different work tools 109 such as dozer blade shown in FIG. 2, the bucket 109 shown in FIG. 3, and auger 111 in FIG. 4. The work tools may be non-powered tools such as the bucket 109 or hydraulically powered work tools, such as a stump grinder, a trencher, or an auger 111. As shown in FIG. 4, auger 111 includes a hydraulically powered auger motor 111a which is driven by the flow of hydraulic fluid through hoses 136 to rotate auger blade 111b which can be a helical screw. As is further described below with regard to the hydraulic schematic of FIG. 4, hydraulic power may be provided to such work tools via the vehicle side hydraulic connections 162 and 164.

The hydraulic system 124 is schematically shown in FIG. 4 connected to an exemplary hydraulic power consuming work tool, hydraulically powered auger 111. Hydraulic system 124 includes a hydraulic pump 148 coupled, through an overrunning clutch 140 to ICE 130 and electric machine 120. A tank 152 provides a reservoir of hydraulic fluid on the work vehicle 100. Intake passage 154 connects the tank 152 to a pump inlet 156. A supply passage 158 connects a pump outlet 160 to the various hydraulically powered components and also to a vehicle side hydraulic fluid supply connection 162 which may be located on an outer portion of the boom 108 near the work tool coupler 114 or on the work tool coupler 114 itself. Also located adjacent to the hydraulic fluid supply connection 162 is a vehicle side hydraulic fluid return connection 164 which is connected to a hydraulic fluid return passage 166. The hydraulic fluid return passage 166 connects the hydraulic fluid return connection 164 and the low pressure side of the various hydraulically powered components such as the control valves 117 and 119 associated with hydraulic actuators 116 and 118 to the tank 152.

In response to operator commands, controller 128 operates at least one of the ICE 130 and the electric machine 120 to drive hydraulic pump 148. Hydraulic pump 148 pumps hydraulic fluid from reservoir 152 through pump outlet 160 and pressurize supply passage 158. Preferably, hydraulic pump 148 is a variable displacement pump that can be controlled by controller 128 to adjust the volume of hydraulic fluid hydraulic pump 148 outputs. Sensors in hydraulic system 124 can monitor operating parameters, such as hydraulic pressures at various points in fluid supply passage 158 and fluid return passage 166 and transmit these signals to controller 128. Controller can adjust the output of the hydraulic pump 148 based on these signals and in response to operator commands. For example, on receiving an operator command to raise boom 108 or tilt work tool coupler 114, controller may control boom valve 117 or coupler valve 119 to extend or retract boom cylinder 116 or tilt cylinder 118. Controller 128 can similarly control work tool valve 121 to adjust the direction and volume of hydraulic fluid supplied to a hydraulically powered work tool 109, such as auger 111. When no operator commands require flow of hydraulic fluid in hydraulic system 124, controller 128 can control the variable displacement hydraulic pump 148 to provide zero hydraulic fluid output.

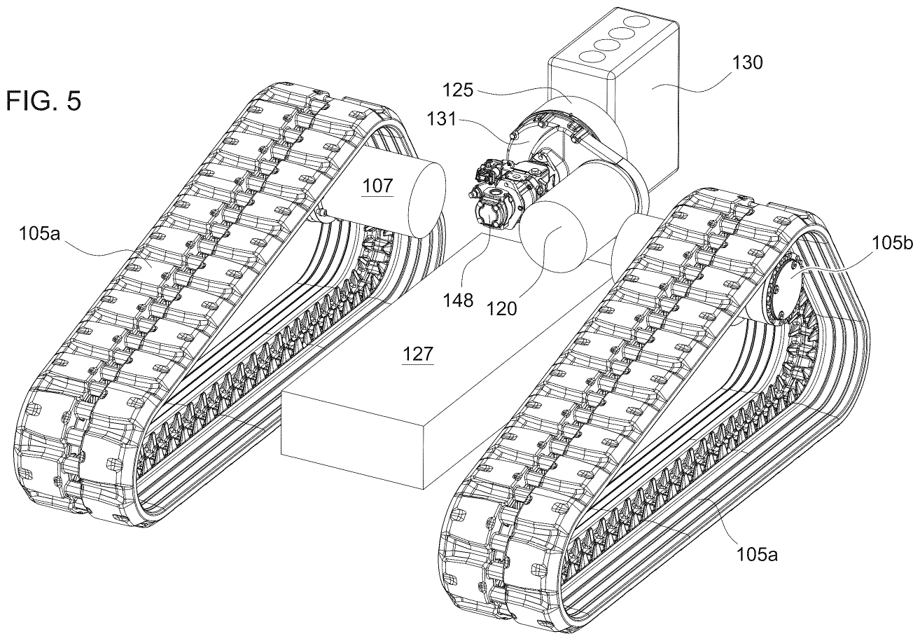

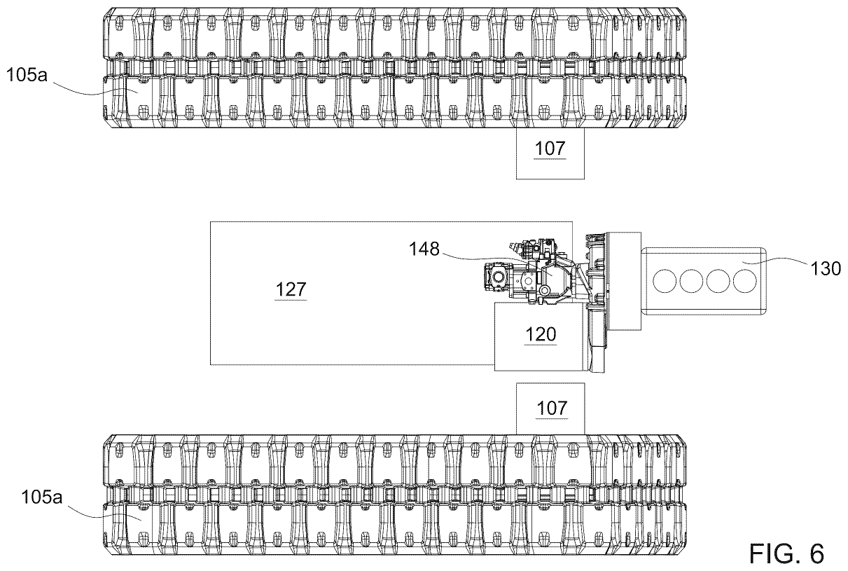

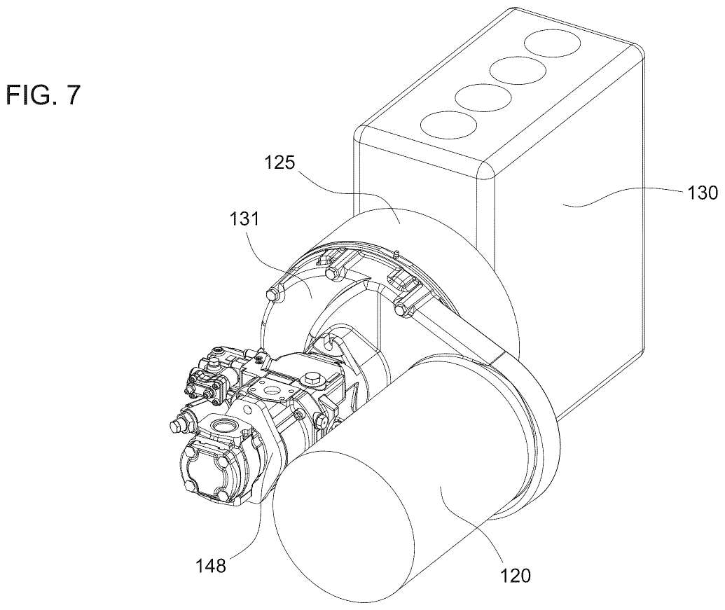

FIG. 5 is an isometric view and FIG. 6 is a top view of a drivetrain of a tracked skid steer loader work vehicle 100 according to a further embodiment. As FIG. 7 shows in more detail, the drivetrain includes ICE 130 which drives electric machine 120 and hydraulic pump 148 via overrunning clutch 140 housed in the ICE's flywheel housing 125. Electric machine 120 is electrically connected to battery 127 via electric power conditioning and control circuitry that manages battery charging and supply of battery power. Electric machine 120 and battery 127 are also electrically connected, either directly or indirectly, via electric power conditioning and control circuitry, to electrical power consuming components such as electric drive motors 107, work vehicle lights, and operator station air conditioning system. Drive motors 107 are each attached to a sprocket 105b. Each of the sprockets engages with the links of its corresponding crawler track 105a. When battery or electric machine 120 are controlled to power drive motors 107, the motors rotate sprockets 105b. Sprockets 105b turn the crawler track 105a to propel the skid steer loader forwards or backwards. Conversely, controller 128 can be configured to control drive motors 107 to retard the skid steer loader when it is travelling, through regenerative braking, and generate electrical power. Controller 128 can direct the electrical power to be stored in battery 127 or direct the power to drive the electric machine and supplement the power provided to the hydraulic pump 148, thereby reducing power demand on ICE 130 and reducing its fuel consumption.

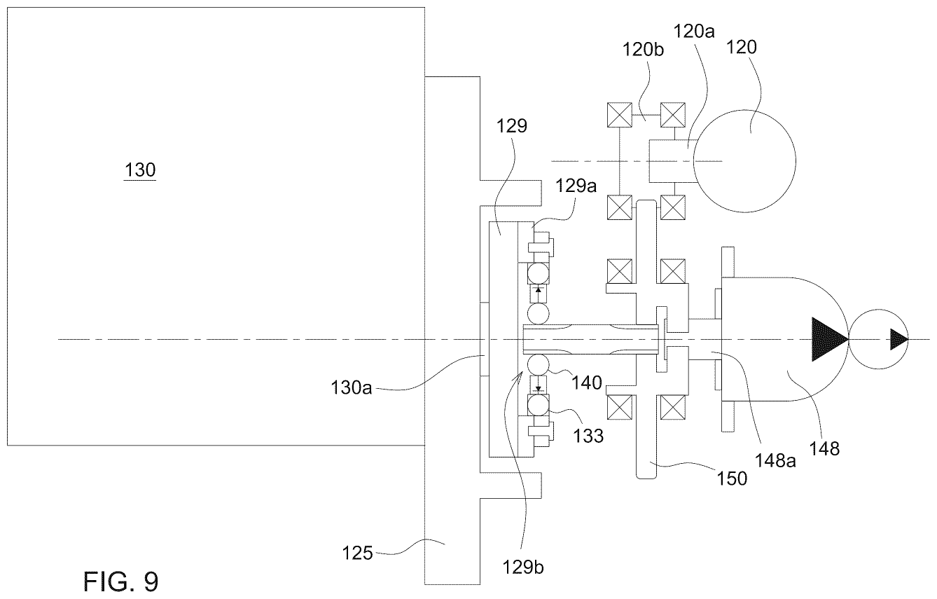

FIG. 9 is a schematic view of a portion of one embodiment of the drivetrain. ICE 130 includes output shaft which is attached to rotate with flywheel 129 housed in flywheel housing 125. Flywheel 129 can include raised mounting points 129a surrounding a central recess 129b area of flywheel 129. A torsional detuner 133 attaches overrunning clutch 140 to the flywheel 129. Raised mounting points 129a and central recess 129b are designed for compact arrangement and attachment of torsional detuner 133 and overrunning clutch 140 to flywheel 129. Torsional detuner 133 operates to reduce or eliminate vibrations that have developed in the crankshaft of ICE 130. The explosive forces acting on the pistons can create vibrations, which thereafter propagate through the crankshaft connected drivetrain components. At certain engine speeds, the vibration can be more noticeable and can be irritating to an operator and can, over time, damage the crankshaft and connected drivetrain components such as hydraulic pump 148 and overrunning clutch 140. Torsional detuner 133 includes a peripheral portion which attaches to flywheel 129 at mounting points 129a and a central opening configured to receive overrunning clutch 140.

Torsional detuners can include energy storing elements located on the periphery of the flywheel and include coil springs or a rubber member as well as additional storage elements that act in an axial direction, relative to the rotation of the flywheel. Optionally, these energy storing elements can cooperate with friction pads or linings to produce friction hysteresis. According to one example, a spring type torsional detuner used for damping vibrations developed in an internal combustion engine can include a planar body, a central hub, a peripheral rim and a plurality of elastically deformable members or springs connecting the hub to the rim. The deformable members can extend outward from the hub to the rim in an outwardly radial spiral. Vibrations developed in the engine can be damped by the relative rotation between the hub and rim.

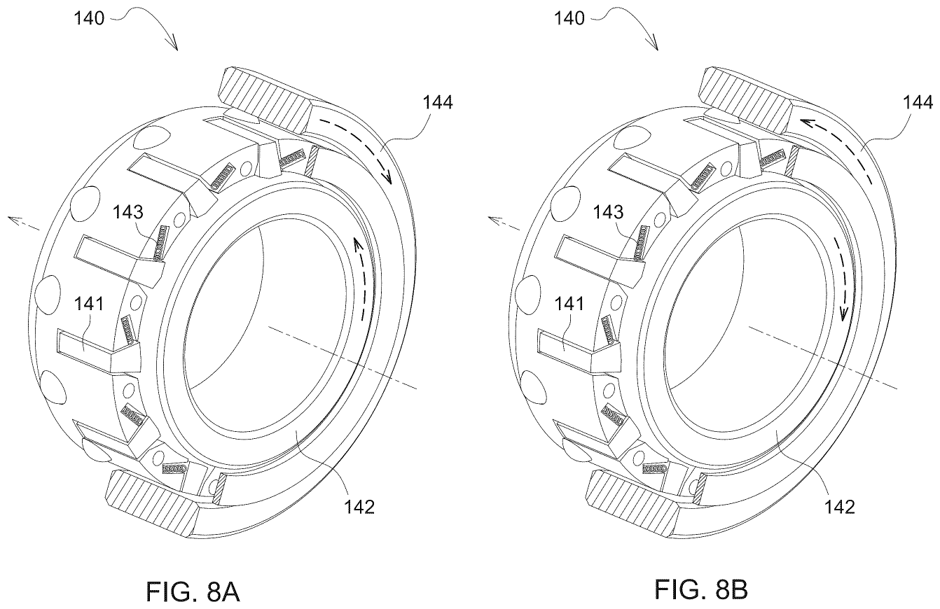

FIGS. 8A and 8B show an embodiment of overrunning clutch 140. In this embodiment, overrunning clutch 140 is a one-way clutch which produces a one-way drive connection between inner race 142 and outer race 144 of the clutch. includes sprags or rollers 141 for releasably driveably connecting the races and the components of a mechanical assembly connected to the races. The one-way overrunning clutch 140 includes at least one sprag or roller 141 retained in cage 143. The sprags or rollers 141 driveably lock two notched or pocketed races together mutually in one rotary direction and allows the races to rotate freely in the other direction. As shown in FIG. 8A, when outer race 144 rotates clockwise relative to inner race 142 as indicated by the arrows, sprags 141 lock inner race 142 and outer race 144 to rotate together. However as shown in FIG. 8B, when outer race 144 rotates counterclockwise relative to inner race, as indicated by the arrows, sprags 141 unbind and permit outer race 144 to rotate freely and independently of inner race 142. The free rotation of the outer race 144 independently of inner race 142 is sometimes referred to as freewheeling. Optionally, overrunning clutch 140 can be a two-way clutch which can be controlled to reverse the relative rotation that locks the inner race to the outer race, and also that permits the inner race to rotate freely with respect to the outer race.

In FIG. 9, overrunning clutch 140 is mounted in central opening of torsional detuner 133 with overrunning clutch outer race 144 attached at points around the central opening. A PTO shaft 135 can be splined at each end to engage with splines on overrunning clutch inner race 142 and splines in an axially located central hole in hybrid drive gear 150, so that inner race 142 is fixedly coupled to rotate with hybrid drive gear 150. Outer race 144 being fixedly coupled to be driven by ICE output shaft 130a via flywheel 129 and torsional detuner 133 is the drive race. Inner race 142 is driven by ICE output shaft whenever ICE output shaft attempts to rotate outer race 142 clockwise relative to inner race 142 and is, thus, the driven race. Hydraulic pump input shaft 148a is coaxially arranged with PTO shaft 135 and hybrid drive gear 150 and couples hydraulic pump 148 to hybrid drive gear 150. Hybrid drive gear 150 includes a gear on its periphery which meshes and engages electric machine gear 120b so that the two gears rotate in mutually opposing directions.

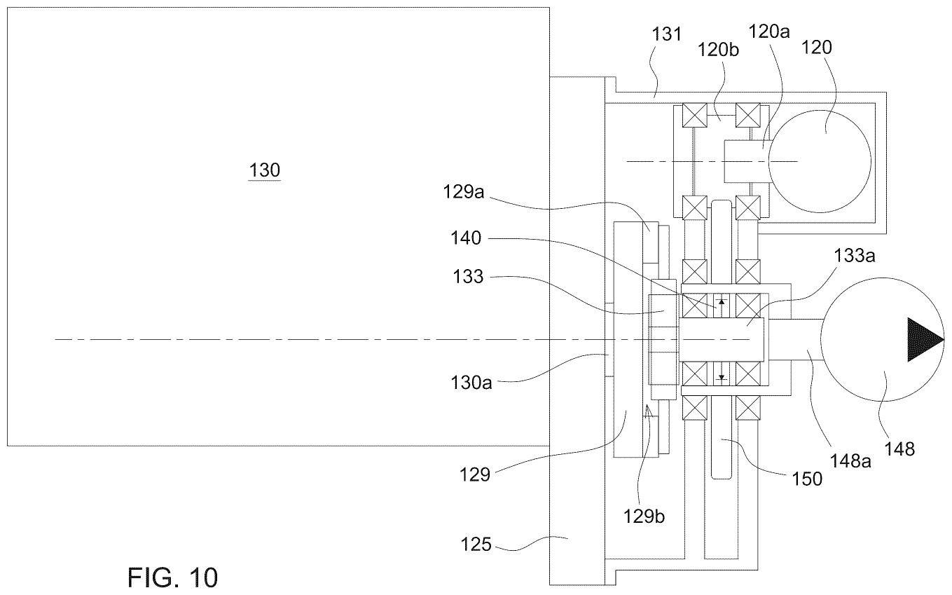

FIG. 10 is a schematic view of a portion of a second embodiment of the drivetrain. In FIG. 10, ICE 130 is coupled to hydraulic pump 148 and electric machine 120 via overrunning clutch 140 and hybrid drive gear 150, similar to the embodiment in FIG. 9. Pump drive housing 131 at least partially encloses and houses flywheel 129, torsional detuner 133, overrunning clutch 140, housing hybrid drive gear 150, electric machine 120, electric machine shaft 120a, and electric machine gear 120b. Pump drive housing 131 includes one or more walls that provide a receptacle or sump capable of holding lubricating oil. Pump drive housing 131 can be shaped so that portions of flywheel 129 or hybrid drive gear 150 can dip into lubricating oil pooled at the bottom of pump drive housing and splash or spray the lubricant onto nearby components, such as overrunning clutch 140, electric drive gear 120b and torsional detuner 133 to lubricate or cool these components.

In this second embodiment, torsional detuner 133 is attached to raised flywheel mounting points 129a around its periphery and includes an adapter at its center to attached to a detuner shaft 133a which is concentric with torsional detuner 133. Detuner shaft 133a engages overrunning clutch inner race 142 so that torsional detuner, 133 is fixedly coupled to rotate with inner race 142 when driven by ICE output shaft 130a. Thus, in this embodiment inner race 142 is the drive race. Overrunning clutch outer race 144 is the driven race and is fixedly coupled to rotate with hybrid drive gear 150. Hybrid drive gear 150 can be configured to be fixedly coupled to rotate with hydraulic pump input shaft 148a which is concentric with hybrid drive gear 150, overrunning clutch 140 and ICE output shaft 130a. Hybrid drive gear 150 includes a gear on its periphery which meshes and engages electric machine gear 120b so that the two gears rotate in mutually opposing directions.

In the embodiments of FIGS. 9 and 10, controller 128 can control the supply of electrical power to electric machine 120 to rotate electric machine shaft 120a and electric machine gear 120b which is fixedly attached to rotate with the shaft. Electric machine gear 120b engages hybrid drive gear 150. When supplied with electrical power, electric machine 120 can be configured to rotate electric machine gear 120b to drive hybrid drive gear in the same direction as ICE output shaft 130a to supplement the power ICE 130 transmits to hydraulic pump 148, or to drive the pump instead of ICE 130 when ICE 130 is switched off or whenever electric machine 120 rotates hybrid drive gear 150 faster than ICE output shaft 130a and drive race 144. When electric machine 120 rotates hybrid drive gear 150 clockwise faster than ICE output shaft 130a and drive race 144, driven race 142 overruns drive race 142 and rotates free of ICE 130. In such instances, driven race 142 can be described as freewheeling. In such instances, electric machine 120 drive hydraulic pump 148 unassisted by ICE 130. When ICE is operating

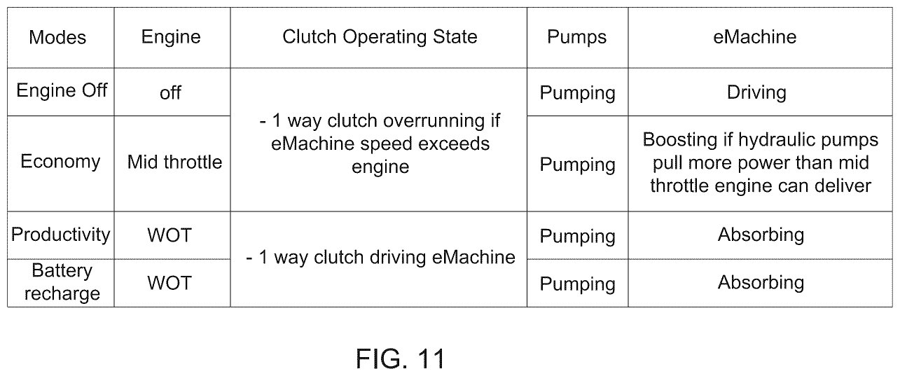

Controller 128 can be configured to coordinate the operation of ICE 130, electric system 126, and hydraulic system 124 according to different modes as shown, for example, in FIG. 11. In one mode, controller 128 can operate ICE 130 to rotate ICE output shaft 130a clockwise when viewed from the ICE 130 towards flywheel 129. Because the load of hydraulic pump 148 on the driven race in the embodiments of FIGS. 9 and 10 tends to retard rotation of the driven race, the clockwise rotation of output shaft 130a and drive race locks the driven race to the drive race. Output shaft 130a thus rotates the driven race along with hybrid drive gear 150, hydraulic pump input shaft 148a, electric machine gear 120b and electric machine shaft 120a. When driven by ICE 130, controller 128 can operate electric machine 120 to generate electrical power. Controller 128 can operate electrical system 126 to charge battery 127 or power electric drive motor 107 or other electrical power-consuming devices using the electrical power electric machine 120 generates. Controller 128 can also operate hydraulic system 124 by adjusting the displacement of variable displacement hydraulic pump 148 to control the load (i.e., the power or torque required to rotate hydraulic pump input shaft 148a at some speed) demand on ICE 130 in accordance with the performance requested by operator commands. When controller 128 receives no operator command requiring actuation of hydraulically powered work tools or actuators, controller 128 can adjust hydraulic pump 148 to produce no output and place the hydraulic system 124 in standby. With the maximum power available from ICE 130 to drive electric machine 120, controller 128 can maximize the amount of electrical power electric machine 120 generates for use in charging battery 127.

In a second mode, controller 128 can stop operation of ICE 130 and drive electric machine 120 to power hydraulic pump 148 using only electric power. Controller 128 controls battery 127 to supply electrical power to drive electric machine 120. In this mode, electric machine 120 drives hybrid drive gear 150, and the connected driven race, to rotate clockwise while drive race remains stationary. Therefore, the drive race rotates counterclockwise relative to driven race and driven race of overrunning clutch 140 overruns the drive race. In this mode, controller 128 can also operate hydraulic system 124 by adjusting the displacement of variable displacement hydraulic pump 148 to control the load demand on electric machine 120 in accordance with the performance requested by operator commands.

In a third mode, controller 128 can operate ICE 130 to produce power or torque sufficient to meet a fraction of the load demand of hydraulic pump 148. Controller 128 can also power electric machine 120 using electric power from battery 127 to rotate electric machine shaft 12a and electric machine gear 120b to drive hybrid drive gear 150. Controller 128 controls the power or torque produced by electric machine 120 to supplement the output of ICE 130 to meet the load demand of hydraulic pump 148.

Optionally, using sensors on ICE output shaft 130a and hybrid drive gear 150, controller 128 can monitor overrunning clutch 140 to ensure that driven race does not overrun the drive race. By avoiding overrunning, controller 128 can determine whether the outputs of ICE 130 and electric machine 120 are balanced and can avoid chatter or vibration from intermittent overrunning that could damage drivetrain components. Controller 128 can coordinate the operation of ICE 130 and electric machine 120 to operate ICE 130 at part throttle to reduce fuel consumption and noise generation and adjust the output of electric machine 120 to boost ICE 130 output whenever the hydraulic system 124 demands more power. For example, controller 128 can set a maximum power output for ICE 130 to conserve fuel, limit emissions or noise or may, for example, set a maximum fuel consumption rate or engine speed. Controller 128 can then operate ICE 130 by setting one or more of these maximum values as target operating values for ICE 130 and control electric machine 120 to provide the additional power or torque required to meet hydraulic pump load. As a further option, controller 128 can monitor the performance requested by operator commands, estimate the load demand hydraulic system 124 and/or electrical system 126 would require to provide the requested performance, and set a target output for the hydraulic system 124 and/or electrical system 126 at a fraction of the estimated load demand in order to conserve energy. Controller 128 can then operate ICE 130 and electric machine 120 so as not to exceed the target load demand of the hydraulic pump.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A work vehicle drivetrain, comprising:
an internal combustion engine having an engine output;
a hydraulic pump having a pump input;
an electric machine having an electric machine shaft; and
an overrunning clutch that couples the engine output, the pump input, and the electric machine shaft;
wherein the internal combustion engine can drive the electric machine and pump in a first mode, the internal combustion engine and the electric machine can simultaneously drive the hydraulic pump in a second mode, and the electric machine can drive the hydraulic pump while overrunning the clutch in a third mode.

2. The work vehicle drivetrain of claim 1, wherein the overrunning clutch further comprises a drive race coupled to the engine output and a driven race that couples the overrunning clutch, the pump input, and the electric machine shaft via a coupling gear.

3. The work vehicle drivetrain of claim 2, wherein the drive race of the overrunning clutch is coupled to the engine output via a torsional detuner.

4. The work vehicle drivetrain of claim 3, wherein the torsional detuner is a spring type torsional detuner.

5. The work vehicle drivetrain of claim 1, wherein the overrunning clutch is a one-way clutch.

6. The work vehicle drivetrain of claim 1, wherein the overrunning clutch is a two-way clutch.

7. The work vehicle drivetrain of claim 1, wherein the electric machine is electrically connected to an electric drive motor, the electric drive motor being mechanically connected to a ground engaging unit and configured to drive the vehicle along a ground surface, and wherein the electric machine is configured to supply electric power to the electric drive motor.

8. The work vehicle drivetrain of claim 7, further comprising an electrical power storage system, and a controller configured to control the electrical power storage system, the electric machine, the electric drive motor, the hydraulic pump and the internal combustion engine,
wherein the electrical power storage system is electrically connected to the electric drive motor and the electric machine, and
wherein the controller is further configured to control the electrical power storage system to supply electrical power to the electric machine and to the electric drive motor.

9. The work vehicle drivetrain of claim 8, wherein the controller is further configured to control the electric machine to supply electrical power to the electrical power storage system.

10. The work vehicle drivetrain of claim 8, further comprising a frame, a work tool coupled to the frame, and a positioning actuator hydraulically coupled to the hydraulic pump, the positioning actuator configured to adjust the position of the work tool relative to the frame,
wherein the controller is further configured to control the internal combustion engine and the electric machine to drive the hydraulic pump in the second mode to meet a target hydraulic load output without freewheeling the overrunning clutch.

11. The work vehicle drivetrain of claim 8, further comprising a frame, a hydraulically powered work tool mechanically coupled to the frame, and hydraulically coupled to the hydraulic pump,
wherein the controller is further configured to control the internal combustion engine and the electric machine to drive the hydraulic pump in the second mode to meet a target hydraulic load output without freewheeling the overrunning clutch.

12. A work vehicle comprising:
a frame;
a drivetrain mounted on the frame, the drivetrain including
an internal combustion engine having an engine output,
a hydraulic pump having a pump input,
an electric machine having an electric machine shaft, and
an overrunning clutch coupling the engine output the pump input and the electric machine shaft;
a plurality of ground engaging units for supporting the frame from a ground surface, at least one of the ground engaging units being powered by an electric drive motor to drive the vehicle;
a work tool mechanically coupled to the frame;
wherein the internal combustion engine can drive the electric machine and pump in a first mode, the internal combustion engine and the electric machine can simultaneously drive the hydraulic pump in a second mode, and the electric machine can drive the hydraulic pump while overrunning the clutch in a third mode.

13. The work vehicle of claim 12, wherein the overrunning clutch further comprises a drive race coupled to the engine output and a driven race that couples the overrunning clutch, the pump input, and the electric machine shaft via a coupling gear.

14. The work vehicle of claim 13, wherein the drive race of the overrunning clutch is coupled to the engine output via a torsional detuner.

15. The work vehicle of claim 12, further comprising an electrical power storage system and a controller,
wherein the controller is configured to control the electrical power storage system, the electric machine, the electric drive motor, the hydraulic pump and the internal combustion engine,
wherein the electrical power storage system is electrically connected to the electric drive motor and the electric machine, and
wherein the controller is further configured to control the electrical power storage system to supply electrical power to the electric machine and to the electric drive motor and to control the electric machine to supply electrical power to the electrical power storage system.

16. The work vehicle of claim 15, further comprising a positioning actuator hydraulically coupled to the hydraulic pump and mechanically coupled to the work tool, the positioning actuator configured to adjust the position of the work tool relative to the frame,
wherein the controller is further configured to operate the internal combustion engine and the electric machine to control the positioning actuator to adjust the position of the work tool relative to the frame.

17. The work vehicle of claim 14,
wherein the engine output includes an output shaft and a flywheel attached to rotate with the output shaft, wherein the drive race is an outer race of the overrunning clutch, the outer race coupled to the flywheel via the torsional detuner, wherein the driven race is an inner race of the overrunning clutch and is coupled to a coupling gear via a PTO shaft.

18. The work vehicle of claim 14,
wherein the engine output includes an output shaft and a flywheel attached to rotate with the output shaft,
wherein the drive race is an inner race of the overrunning clutch, the inner race coupled to the flywheel via the torsional detuner,
wherein the driven race is an outer race of the overrunning clutch attached to rotate with the coupling gear,
wherein the electric machine shaft is attached to rotate with an electric machine gear which meshes to rotate with the coupling gear,
wherein the internal combustion engine includes a housing having a wall that at least partially encloses the flywheel, torsional detuner, and coupling gear to form a sump capable of holding a volume of lubricating fluid,
wherein the overrunning clutch and the coupling gear are mounted on a support.

19. The work vehicle of claim 15, wherein in the first mode the controller is configured to the electric machine to charge the electrical power storage system, wherein in the second mode the controller is configured to control the electric machine to supplement a torque the internal combustion engine transmits to the hydraulic pump, and wherein in the third mode the controller is configured to control the electric machine and the electrical power storage system to the drive the hydraulic pump with the internal combustion engine stopped.

20. The work vehicle of claim 19, wherein in the second mode, the controller is configured to monitor a load demand of the hydraulic pump and to adjust the power output of the electric machine and the power output of the internal combustion engine so that the power the electric machine and the internal combustion engine, when combined, transmits to the hydraulic pump does not exceed the monitored load demand of the hydraulic pump.
